(19) United States
(12) Patent Application Publication
(10) Pub. No.: US 2019/0084617 A1
(43) Pub. Date: Mar. 21, 2019

(54) PROCESS FOR PRODUCING A HEAT-TREATED HUB CARRIER PROVIDED WITH A WHEEL BEARING

(71) Applicant: KSM CASTINGS GROUP GMBH, Hildesheim (DE)

(72) Inventors: Thomas BUSCHJOHANN, Nordstemmen (DE); Stefan GEISLER, Sarstedt (DE); Robin KUDRNA, Hildesheim (DE); Heik LACHMUND, Holle (DE)

(73) Assignee: KSM CASTINGS GROUP GMBH, Hildesheim (DE)

(21) Appl. No.: 16/084,495

(22) PCT Filed: Feb. 28, 2017
(86) PCT No.: PCT/DE2017/100157

§ 371 Date: Sep. 12, 2018

(30) Foreign Application Priority Data
Mar. 14, 2016 (DE) 10 2016 104 669.8

(51) Int. Cl. B62D 7/18

(52) U.S. Cl. CPC B62D 7/18; B60G 2206/50; B60G 2206/8402; B60G 2206/82; B60G 2206/8401; B60G 2206/7102

(57) ABSTRACT

The invention relates to a process for producing a heat-treated hub carrier provided with a wheel bearing, the process comprising the successive steps: a) provision of a hub-carrier blank which is preferably cast, b) solution annealing of the hub carrier, c) quenching of the hub carrier, preferably in water and/or air, d) at least partial machining of the hub carrier, e) insertion of the wheel bearing into a recess of the hub carrier, f) re-annealing or hot ageing of the hub carrier.

The invention relates to a method for producing a heat-treated wheel support which is provided with a wheel bearing.

In the case of motor vehicles, each wheel is mounted on a wheel support which is usually connected via a plurality of links, for example longitudinal and transverse links, to the vehicle body, possibly via a subframe. The wheel support usually has a bore for receiving a wheel bearing, via which, in particular, a wheel hub is mounted on the wheel support. In turn, a brake disk and the wheel rim are mounted on the wheel hub itself, usually by means of screws. The wheel hub is driven via a drive shaft which is coupled via a transmission to the engine.

The invention is based on the object of developing known heat-treated wheel supports which are to be provided with a wheel bearing.

Said object is achieved by way of a method which has the features of claim 1. Developments and advantageous refinements of the invention can result from the subclaims.

The method according to the invention for producing a heat-treated wheel support which is to be provided with a wheel bearing comprises the method steps which follow one another:

a) providing of a wheel support blank which is preferably cast
b) solution annealing of the wheel support
c) quenching of the wheel support, preferably in water and/or air
d) at least partial machining of the wheel support
e) introducing of the wheel bearing into a receptacle of the wheel support
f) tempering or artificial ageing of the wheel support

The method according to the invention substantially facilitates the introducing of the wheel bearing into the receptacle of the wheel support, since the wheel support does not yet have its final strength at the time of the introducing of the wheel bearing into the receptacle, which final strength is achieved only after the tempering. The wheel support is therefore still plastically deformable at the time of the introducing of the wheel bearing into the receptacle. As a result, the wheel bearing can be positioned in the receptacle in a very compact manner and with an optimized press fit.

It can be advantageous if the provided wheel support is produced by way of casting, preferably from an aluminum alloy. As a result of the use of an aluminum alloy, not only is a reduction of unsprung masses achieved, but the plastic deformability is also ensured in a manner which is essential to the invention after the solution annealing for the simpler introducing of the wheel bearing into the receptacle of the wheel support. After the final tempering and/or artificial ageing, a wheel support which is produced from an aluminum alloy in addition meets the requirements made of a wheel support with regard to the stiffness, yield strength, ductility, the dynamic strength, the insensitivity to corrosion, the satisfactory workability, meeting of the required mechanical properties, the suitability for machining with the removal of material, and the economic viability.

It can be advantageous if the solution annealing and tempering of the wheel support corresponds to a T6 heat treatment. According to the invention, the wheel support is given the desired strength in this way, the wheel bearing being positioned according to the invention in the receptacle of the wheel support before the final strength is reached.

It can be advantageous if the solution annealing takes place at a temperature of at least 500° C., preferably of at least 510° C., particularly preferably of at least 520° C. It can be advantageous if the solution annealing takes place at a temperature of at most 560° C., preferably of at most 545° C., particularly preferably of at most 535° C. A temperature of 525° C. is very particularly preferable for the solution annealing.

It can be advantageous if the duration of the solution annealing is at most 10 hours, preferably at most 9 hours, particularly preferably at most 8 hours. It can be advantageous if the duration of the solution annealing is at least 5 hours, preferably at least 6 hours.

It can be advantageous if the tempering takes place at a temperature of at least 160° C., preferably of at least 165° C., particularly preferably of at least 170° C. It can be advantageous if the tempering takes place at a temperature of at most 190° C., preferably of at most 185° C., particularly preferably of at most 180° C. A temperature of 175° C. is very particularly preferable for the tempering.

It can be advantageous if the duration of the tempering is at most 8 hours, preferably at most 7 hours, particularly preferably at most 6 hours. It can be advantageous if the duration of the tempering is at least 3 hours, preferably at least 4 hours.

It can be advantageous if a wheel bearing of what is known as the first generation (GEN1) is introduced as wheel bearing into the receptacle of the wheel support.

In the case of a wheel bearing of what is known as the first generation (GEN1), two rows of rolling bodies are usually arranged between two inner rings and an outer ring. Here, the structure of the rings is roughly cylinder shell-shaped, the side which faces the rolling bodies being configured in each case for receiving the latter. Here, the wheel bearing per se forms an integrated module which is plugged into the receptacle or bore of the wheel support which is provided for this purpose. The outer ring of the wheel bearing which is introduced into the receptacle is assigned to the wheel support. Wheel bearing units of the first generation represent a simple and compact wheel bearing system which can be used both for driven and non-driven wheels.

In the case of wheel bearings of what is known as the second generation (GEN2), the wheel hub is in contrast to some extent of integrated configuration with an inner ring, that is to say the inner ring has a flange, on which the brake disk and the rim are mounted. In the case of what is known as the third generation (GEN3), the outer ring additionally has a further flange which is secured on the wheel support by means of screw connections.

It can be advantageous if the introducing of the wheel bearing into the receptacle of the wheel support takes place by way of being pressed in, which is known to a person skilled in the art.

It can be advantageous if the wheel support is heated after the machining of the wheel support and before the introducing of the wheel bearing into the receptacle of the wheel support. The heating preferably takes place in such a way that the introducing of the wheel bearing is facilitated, in particular, by way of being pressed in, the heating not corresponding to tempering and/or artificial ageing of the wheel support.

It can be advantageous if the introducing of the wheel bearing into the receptacle of the wheel support after the heating takes place by way of being shrunk in. The wheel bearing is therefore shrunk in by way of the temperature difference in a simple way.

It can be advantageous if the wheel bearing is inserted in the axial direction into the receptacle of the wheel support and is secured axially there. To this end, it can be advantageous if securing means are provided on at least one side, preferably on both sides of the wheel bearing.

It can be advantageous if a securing means is configured as a radially inwardly extending shoulder of the wheel support. It can be advantageous if the radially inwardly extending shoulder of the wheel support is produced by way of flanging of an edge which runs around the receptacle after introducing of the wheel bearing into the receptacle.

It can be advantageous if a securing means is configured as a securing ring which is inserted into the wheel support.

It can be advantageous if the wheel bearing is secured in the receptacle of the wheel support between a radially inwardly extending shoulder of the wheel support and a securing ring which is inserted into the wheel support.

The radially inwardly extending shoulder can also be considered to be a type of inwardly extending flange. Here, the securing ring (also called a groove ring or Seeger ring) engages into a tangentially circumferential groove of the wheel support and therefore limits or prevents an axial movement of the wheel bearing.

It can be advantageous if the wheel bearing is secured in the receptacle of the wheel support between two securing rings which are inserted into the wheel support.

It can be advantageous if the wheel bearing is secured in the receptacle of the wheel support between a radially inwardly extending shoulder of the wheel support and a further radially inwardly extending shoulder of the wheel support, which further radially inwardly extending shoulder is produced by way of flanging an edge which runs around the receptacle after introducing of the wheel bearing into the receptacle. As a result, sufficient axial fixing is ensured in every case, even at high temperatures.

It can be advantageous if the wheel bearing is secured between a securing ring which is inserted into the wheel support and a radially inwardly extending shoulder of the wheel support, which radially inwardly extending shoulder is produced by way of flanging an edge which runs around the receptacle after introducing of the wheel bearing into the receptacle.

It can be advantageous for some applications if the wheel support is produced using the high pressure die casting method. It can be advantageous for other applications if the wheel support is produced using the gravity die casting method. It can be advantageous for certain applications if the wheel support is produced using the squeeze casting method. It can be advantageous for defined applications if the wheel support is produced using the counter-pressure casting method (CPC). Wheel supports which are distinguished by forging-like strengths with simultaneously high elongation are obtained by way of the counter-pressure casting method (CPC).

Further details and advantageous refinements of the invention also result from the following description in conjunction with the drawing, in which:

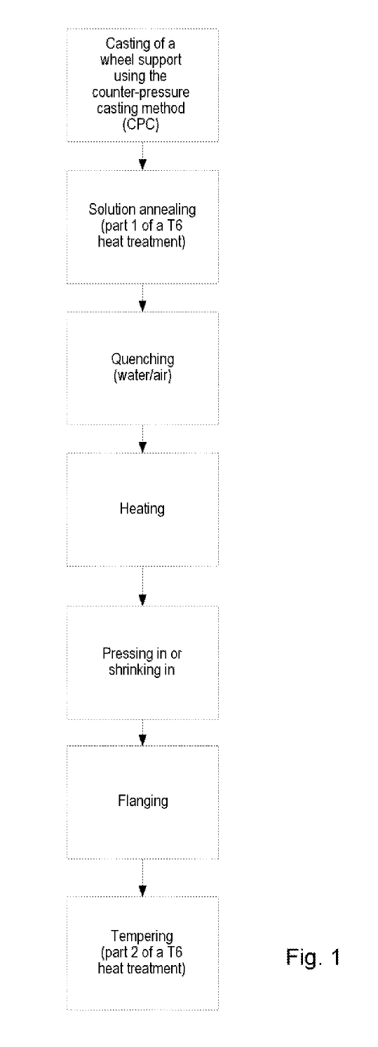

FIG. 1 diagrammatically shows a flow chart of a method according to the invention, and

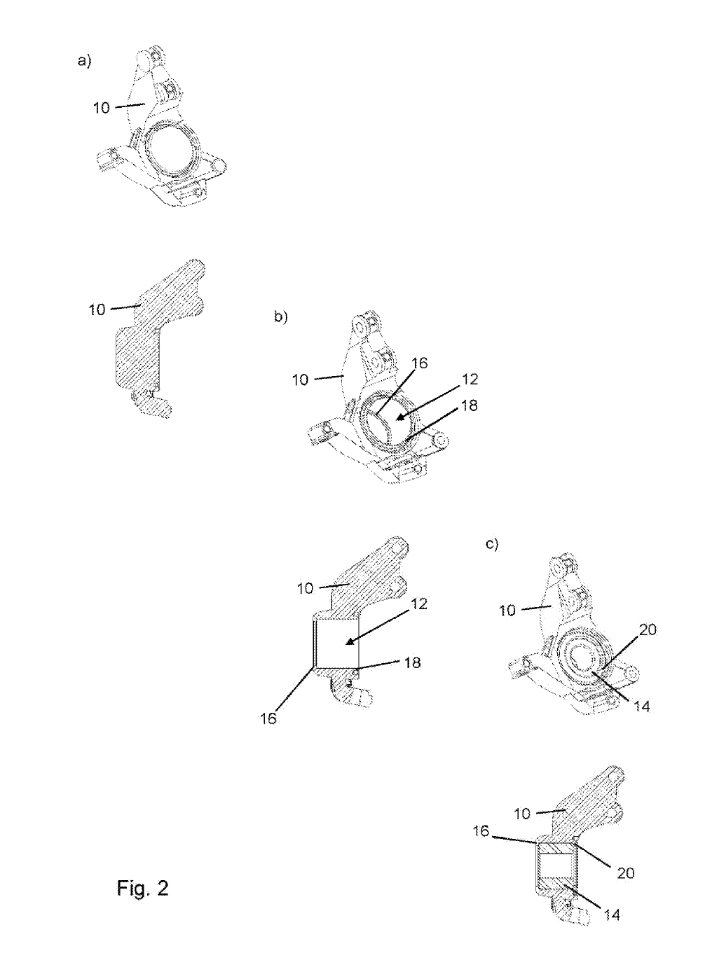

FIG. 2 diagrammatically shows three situations during the method according to the invention, namely a wheel support, in each case in a perspective illustration and in a sectional illustration, to be precise a) as a cast blank, b) as a machined part without a wheel bearing, and c) as a finally mounted part.

In order to avoid repetitions, identical designations are used in the figures in so far as they denote identical components.

FIG. 1 diagrammatically shows a flow chart of a method according to the invention for producing a heat-treated wheel support which is provided with a wheel bearing, comprising the method steps which follow one another:
casting of a wheel support 10 from an aluminum alloy using the counter-pressure casting method (CPC)
solution annealing of the wheel support 10 as a first part of a provided T6 heat treatment
quenching of the wheel support 10 in preferably water and/or air
at least partial machining of the wheel support 10, in particular for providing a receptacle 12 or bore which runs in the axial direction of the wheel support 10 for a wheel bearing 14 of what is known as the first generation (GEN1)
heating of the wheel support 10, the heating not comprising any tempering and/or artificial ageing of the wheel support 10
introducing of the wheel bearing 14 into the receptacle 12 of the wheel support 10 by way of being pressed in and/or shrunk in, the wheel bearing 14 being secured axially on the one side of the receptacle 12 by way of a radially inwardly extending shoulder 16 of the wheel support 10
flanging of an edge 18 which runs around the receptacle 12 on the other side of the receptacle 12 after introducing of the wheel bearing 14, with the result that a further radially inwardly extending shoulder 20 of the wheel support 10 is produced, by way of which further radially inwardly extending shoulder 20 the wheel bearing 14 is secured axially
tempering and/or artificial ageing of the wheel support 10 as a second part of a provided T6 heat treatment, in order to obtain the envisaged strength of the wheel support 10.

To this end, FIG. 2 diagrammatically shows three situations during the method according to the invention, namely a wheel support 10, in each case in a perspective illustration and in a sectional illustration, to be precise a) as a cast blank, b) as a machined part without a wheel bearing 14, and c) as a finally mounted part with a shrunk-in wheel bearing 14 and a flanged shoulder 20.

### LIST OF DESIGNATIONS

### (Is Part of the Description)

10 Wheel support
12 Receptacle
14 Wheel bearing
16 Shoulder
18 Edge
20 Shoulder

1. A method for producing a heat-treated wheel support which is provided with a wheel bearing, comprising the method steps which follow one another:
a) providing of a wheel support blank which is preferably cast
b) solution annealing of the wheel support
c) quenching of the wheel support, preferably in water and/or air
d) at least partial machining of the wheel support
e) introducing of the wheel bearing into a receptacle of the wheel support
f) tempering and/or artificial ageing of the wheel support

2. The method, in particular as claimed in claim 1, wherein the solution annealing and tempering of the wheel support corresponds to a T6 heat treatment.

3. The method, in particular as in claim 1, wherein the introducing of the wheel bearing into the receptacle of the wheel support takes place by way of being pressed in.

4. The method, in particular as claimed in claim 1, wherein the wheel support is heated after the at least partial machining of the wheel support and before the introducing of the wheel bearing into the receptacle of the wheel support.

5. The method, in particular as claimed in claim 1, wherein the introducing of the wheel bearing into the receptacle of the wheel support after the heating takes place by way of being shrunk in.

6. The method, in particular as claimed in claim 1, wherein the wheel bearing is secured axially in the receptacle of the wheel support.

7. The method, in particular as claimed in claim 1, wherein the wheel bearing is secured in the receptacle of the wheel support between a radially inwardly extending shoulder of the wheel support and a securing ring which is inserted into the wheel support.

8. The method, in particular as claimed in claim 1, wherein the wheel bearing is secured in the receptacle of the wheel support between two securing rings which are inserted into the wheel support.

9. The method, in particular as claimed in claim 1, wherein the wheel bearing is secured in the receptacle of the wheel support between a radially inwardly extending shoulder of the wheel support and a further radially inwardly extending shoulder of the wheel support, which further radially inwardly extending shoulder is produced by way of flanging of an edge which runs around the receptacle after introducing of the wheel bearing into the receptacle.

10. The method, in particular as claimed in claim 1, wherein the wheel bearing is secured between a securing ring which is inserted into the wheel support and a radially inwardly extending shoulder of the wheel support, which radially inwardly extending shoulder is produced by way of flanging of an edge which runs around the receptacle after introducing of the wheel bearing into the receptacle.

11. The method, in particular as claimed in claim 1, wherein the wheel support is produced from an aluminum alloy.

12. The method, in particular as claimed in claim 1, wherein the wheel support is produced using the high pressure die casting method, using the gravity die casting method, using the squeeze casting method or preferably using the counter-pressure casting method (CPC).

13. The method, in particular as claimed in claim 1, wherein a wheel bearing of what is known as the first generation (GEN1) is introduced as wheel bearing into the receptacle of the wheel support.
